(19) United States
(12) Patent Application Publication
(10) Pub. No.: US 2009/0269046 A1
(43) Pub. Date: Oct. 29, 2009

(54) LENS BARREL WITH SHAKE DETECTION FUNCTION

(76) Inventors: Satoshi Yamazaki, Tokyo (JP); Tetsuji Kamata, Tokyo (JP)

Correspondence Address: DITTHAVONG MORI & STEINER, P.C., 918 Prince St., Alexandria, VA, 22314, US

(21) Appl. No.: 12/065,214

(22) PCT Filed: Sep. 12, 2006
(86) PCT No.: PCT/JP2006/318035

§ 371 Date: Feb. 28, 2008

(51) Int. Cl. G03B 17/00

(52) U.S. Cl. 396/55

(57) ABSTRACT

A lens barrel with high shake detection accuracy includes a stationary tube that supports an imaging optical system and a shake detection sensor that detects a shake along a predetermined detection axis, the shake detection sensor being attached to the stationary tube with the detection axis substantially orthogonal to an optical axis of the imaging optical system.

### TECHNICAL FIELD

The present invention relates to a lens barrel with a shake detecting function that is provided with a correcting function for correcting an image shake caused by such as camera shake.

### BACKGROUND ART

Conventionally, there is known a lens barrel with a shake detecting function for correcting an image shake by use of a driving device for driving an image shake correcting optical system by detecting a rotational shake of a camera in upward, downward, rightward or leftward direction using an angular velocity sensor disposed on an outer periphery of a stationary tube.

FIG. 8 illustrates an attachment structure of an angular velocity sensor in a conventional lens barrel with a shake detecting function. In this attachment structure, a half-ring shaped glass-epoxy substrate 2 is disposed as a collar on an outer periphery of a stationary tube 1, and a first angular velocity sensor 3 is mounted on the glass-epoxy substrate 2 at an upward position of the stationary tube 1 so as to have a sensitivity axis 3a thereof in a rightward and leftward direction. Also, a second angular velocity sensor 4 is mounted on the glass-epoxy substrate 2 at a lateral position of the stationary tube 1 so as to have a sensitivity axis 4a thereof in an upward and downward direction. Here, sound insulating cases 5 are provided for the first and second angular velocity sensors 3 and 4, and the glass-epoxy substrate 2 is fixed to a side of the stationary tube 1 with a screw 7 via a rubber bush 6.

For detecting a rotational shake of a lens barrel in an upward, downward, rightward, or leftward direction with high accuracy using such an attachment structure, it is necessary to dispose the sensitivity axis 3a of the first angular velocity sensor 3 and the sensitivity axis 4a of the second angular velocity sensor 4 perpendicularly to an optical axis 8 of an imaging optical system and also to dispose the sensitivity axis 3a of the first angular velocity sensor 3 and the sensitivity axis 4a of the second angular velocity sensor 4 orthogonally to each other.

Patent Document 1: Japanese Unexamined Patent Application Publication No. H07-270847

### DISCLOSURE OF THE INVENTION

### Problems to be Solved by the Invention

In the conventional attachment structure, however, there has been a problem that, since the first angular velocity sensor 3 and the second velocity sensor 4 are mounted on the glass-epoxy substrate 2 before the glass-epoxy substrate 2 is attached to the stationary tube 1, an attachment error of the glass-epoxy substrate 2 occurs when the glass-epoxy substrate 2 is attached to the stationary tube 1 which makes it difficult to attach the first angular velocity sensor 3 and the second angular velocity sensor 4 to the stationary tube 1 with high accuracy.

The present invention has been made for solving the above conventional problem, and an object of the present invention is to provide a lens barrel with a shake detecting function in which a shake detection sensor can be attached to a stationary tube easily, securely, and with high accuracy.

### Means for Solving the Problems

A lens barrel with a shake detecting function of a first invention includes a stationary tube that supports an imaging optical system and a shake detection sensor that detects a shake along a predetermined detection axis, the shake detection sensor being attached to the stationary tube with the detection axis substantially orthogonal to an optical axis of the imaging optical system.

A lens barrel with a shake detecting function of a second invention is the lens barrel with a shake detecting function according to the first invention, further including a shake correction part that corrects an image shake of a captured image by the imaging optical system based on information from the shake detection sensor.

A lens barrel with a shake detecting function of a third invention is the lens barrel with a shake detecting function according to the first or second invention, wherein the stationary tube is provided with a planar part parallel to the optical axis of the imaging optical system and the shake detection sensor is fixed on the planar part.

A lens barrel with a shake detecting function of a fourth invention is the lens barrel with a shake detecting function according to any one of the first to third inventions, wherein the planar parts are provided at two positions on an outer periphery of the stationary tube spaced apart from each other by an angle of 90 degrees.

A lens barrel with a shake detecting function of a fifth invention is the lens barrel with a shake detecting function according to any one of the first to fourth inventions, wherein the shake detection sensor is an angular velocity sensor utilizing natural frequency of a single crystal material.

A lens barrel with a shake detecting function of a sixth invention is the lens barrel with a shake detecting function according to any one of the second to fifth inventions, wherein the stationary tube integrates a detachable part that is detachable from a camera body containing a medium for recording the captured image.

A lens barrel with a shake detecting function of a seventh invention is the lens barrel with a shake detecting function according to any one of the second to sixth inventions, wherein the shake correction part drives at least a part of an imaging system that includes the imaging optical system and the medium for recording the captured image.

A lens barrel with a shake detecting function of an eighth invention is the lens barrel with a shake detecting function according to any one of the first to seventh inventions, wherein the shake detection sensor is fixed to the planar part via a flexible printed circuit substrate.

A lens barrel with a shake detecting function of a ninth invention is the lens barrel with a shake detecting function according to the eighth invention, wherein two or more of the shake detection sensors are provided on the flexible printed circuit substrate.

A lens barrel with a shake detecting function of a tenth invention is the lens barrel with a shake detecting function according to the ninth invention, wherein the flexible printed circuit substrate is disposed along a circumferential direction of the stationary tube.

A lens barrel with a shake detecting function of an eleventh invention is the lens barrel with a shake detecting function according to the tenth invention, further including an ultrasonic motor driving the imaging optical system, the ultrasonic motor being disposed on the stationary tube at a part where the flexible printed circuit substrate is not disposed.

A lens barrel with a shake detecting function of a twelfth invention is the lens barrel with a shake detecting function according to the eighth invention, wherein the flexible printed circuit substrate includes an attachment to which the shake detection sensor is mounted, the attachment being fixed to the planar part.

A lens barrel with a shake detecting function of a thirteenth invention is the lens barrel with a shake detecting function according to the twelfth invention, wherein the attachment is fixed to the planar part with a double-sided tape.

An electronic device of a fourteenth invention includes the lens barrel according to any one of the first to thirteenth inventions.

An imaging method of a fifteenth invention includes the step of attaching a shake detection sensor to a lens barrel such that a detection axis of the shake detection sensor is substantially orthogonal to an axis direction of the lens barrel.

### Advantages of the Invention

A lens barrel with high shake detection accuracy can be provided.

A lens barrel easily manufactured can be provided.

An imaging method for high shake detection accuracy can be provided.

### BRIEF DESCRIPTION OF THE DRAWINGS

FIG. 1 is an explanatory diagram illustrating a first embodiment of a lens barrel with a shake detecting function according to the present invention.

FIG. 2 is an explanatory diagram illustrating details of a correcting lens driving mechanism shown in FIG. 1.

FIG. 3 is an explanatory diagram illustrating details of an attachment structure of an angular velocity sensor to a stationary tube shown in FIG. 1.

FIG. 4 is an explanatory diagram illustrating details of the angular velocity sensor shown in FIG. 3.

FIG. 5 is an explanatory diagram illustrating a second embodiment of a lens barrel with a shake detecting function according to the present invention.

FIG. 6 is a side view illustrating the lens barrel with a shake detecting function shown in FIG. 5.

FIG. 7 is an explanatory diagram illustrating a flexible printed circuit substrate shown in FIG. 5.

FIG. 8 is an explanatory diagram illustrating an attachment structure of a conventional angular velocity sensor to a stationary tube.

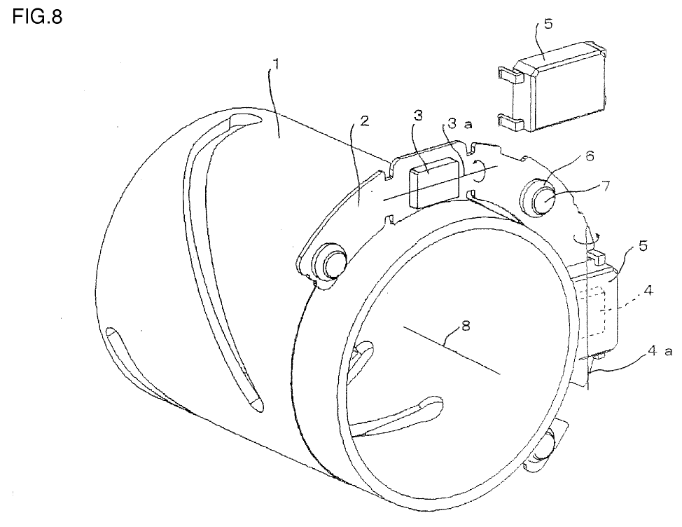

### BEST MODE FOR CARRYING OUT THE INVENTION

Hereinbelow embodiments according to the present invention will be described in detail with reference to the drawings.

### FIRST EMBODIMENT

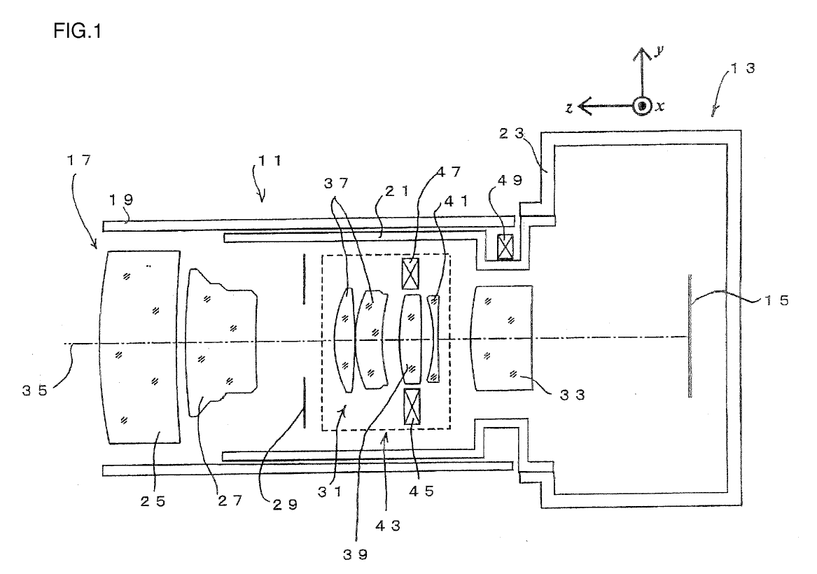

FIG. 1 illustrates a state in which a lens barrel with a shake detecting function (hereinafter, called lens barrel) 11 according to a first embodiment of the present invention is mounted to a camera 13.

The lens barrel 11 includes an imaging optical system 17 that focuses an object image onto an image plane 15 of the camera 13. On the image plane 15, there is disposed a silver halide film or an amplification type solid-state image pickup device such as a CCD or a CMOS. The lens barrel 11 includes an outer tube 19 and a stationary tube 21. The stationary tube 21 is disposed within the outer tube 19 and detachably fixed to a body 23 of the camera 13 at an end thereof on the side of the image plane 15.

The imaging optical system 17 is a zoom lens constituted of four lens groups including a first lens group 25, a second lens group 27, an aperture 29, a third lens group 31, and a fourth lens group 33. The first lens group 25, the second lens group 27, the aperture 29, the third lens group 31, and the fourth lens group 33 are moved along a direction of an optical axis 35 (direction of the arrow z) by a cam mechanism (not shown in the drawing) and thereby the imaging optical system 17 performs changing of magnifying power. Also, movement of the second lens group 27 along the direction of the optical axis 35 (direction of arrow z) performs focus adjustment.

The third lens group 31 includes a lens group 37, an image shake correcting lens 39, and a lens group 41. The image shake correcting lens 39 performs image shake correction by moving in the direction perpendicular to the optical axis 35 (direction of arrow y) and in the direction perpendicular to the page (direction of arrow x). This image shake correcting lens 39 is driven by a correction lens driving mechanism 43 described below.

The correction lens driving mechanism 43 includes an actuator 45 for driving the image shake correcting lens 39 and a correction-lens-position detection sensor 47 for detecting a position of the image shake correcting lens 39.

The aperture 29, the third lens group 31, the correction lens driving mechanism 43, and the fourth lens group 33 are included within the stationary tube 21, and an angular velocity sensor 49 is disposed on an outer periphery of the stationary tube 21.

The angular velocity sensor 49 detects an angular velocity component of vibration applied to a camera system that includes the camera 13 and the lens barrel 11. For this angular velocity sensor, there is used a low-frequency detection angular-velocity sensor for detecting a low frequency component of a vibration angular velocity applied to the camera system. The low-frequency detection angular-velocity sensor detects so called camera shake that occurs mostly when the camera 13 is held by hands.

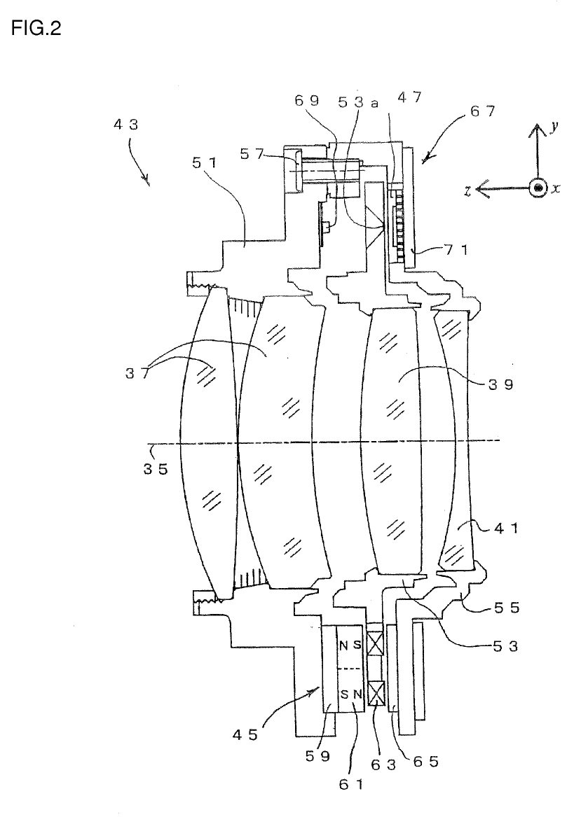

FIG. 2 illustrates details of the correction lens driving mechanism 43 for driving the image shake correcting lens 39.

The correction lens driving mechanism 43 includes a front lens chamber 51, a holding frame 53, and a rear lens chamber 55 disposed within the stationary tube 21. The lens group 37 is held in the front chamber 51. The image shake correcting lens 39 is held by the holding frame 53. The lens group 41 is held in the rear lens chamber 55.

The front lens chamber 51 is fixed to the rear lens chamber 55 with a screw 57 via the holding frame 53. The holding frame 53 is supported by the rear lens chamber 55 with a guiding mechanism (not shown in the drawing), and is supported with the guiding mechanism so as not to interfere with the front lens chamber 51 and the rear lens chamber 55 during being driven. Also, the holding frame 53 is supported so as to be movable only in the direction of the arrow x and the arrow y without rotating around the optical axis 35.

The actuator 45 including a VCM (Voice Coil Motor) is disposed between the front lens chamber 51 and the rear lens chamber 55. This actuator 45 includes a lower yoke 59, a permanent magnet 61, a coil 63, and an upper yoke 65.

The lower yoke 59 is fixed to the front lens chamber 51. The permanent magnet 61 is magnetized to have bi-poles and fixed to the lower yoke 59. The coil 63 is loop-shaped and fixed to the holding frame 53. The upper yoke 65 is fixed to the rear lens chamber 55.

A magnetic circuit is formed by the lower yoke 59, the permanent magnet 61, and the upper yoke 65 to provide a magnetic flux density in a gap between the permanent magnet 61 and the upper yoke 65. Then, since there is the coil 63 within the gap with the magnetic flux density, a driving force is generated in the direction of the arrow y and the image shake correcting lens 39 is driven to move in the direction of the arrow y, when electric current is flown in the coil 63. Similarly, another one of the actuator 45, which is disposed in a position shifted by 90 degrees around the optical axis 35, can drive the image shake correcting lens 39 to move in the direction of the arrow x.

A correction-lens-position detecting part 67 is disposed on the correction lens driving mechanism 43 at a side opposite to the actuator 45. This correction-lens-position detecting part 67 includes the correction-lens-position detection sensor 47, a slit 53a, and an LED 69 (Light Emitting Diode).

The correction-lens-position detection sensor 47 is electrically connected and fixed to a substrate 71. The correction-lens-position detection sensor 47 may be any sensor that can detect a position of the image shake correcting lens 39. In this embodiment, a known PSD (Position Sensitive Detector) is used for detecting a center of gravity position of light intensity projected on a detecting surface of a sensor. The substrate 71 is fixed to the rear lens chamber 55 with a screw (not shown in the drawing).

The slit 53a is formed on the holding frame 53 at a position facing the correction-lens-position detection sensor 47. The LED 69 is fixed to the front lens chamber 51 at a position facing the slit 53a. Therefore, light emitted from the LED 69 passes through the slit 53a and only the light having passed therethrough is projected on the correction-lens-position detection sensor 47. Then, since the slit 53a is formed on the holding frame 53 and the slit 53a moves the same as the image shake correcting lens 39, a position of the image shake correcting lens 39 in the direction of the arrow y can be detected from an output signal of the correction-lens-position detection sensor 47. Another one of this correction lens position detecting part 67 is disposed at a position shifted by 90 degrees around the optical axis 35 the same as the actuator 45, and can detect a position of the image shake correcting lens 39 in the direction of the arrow x.

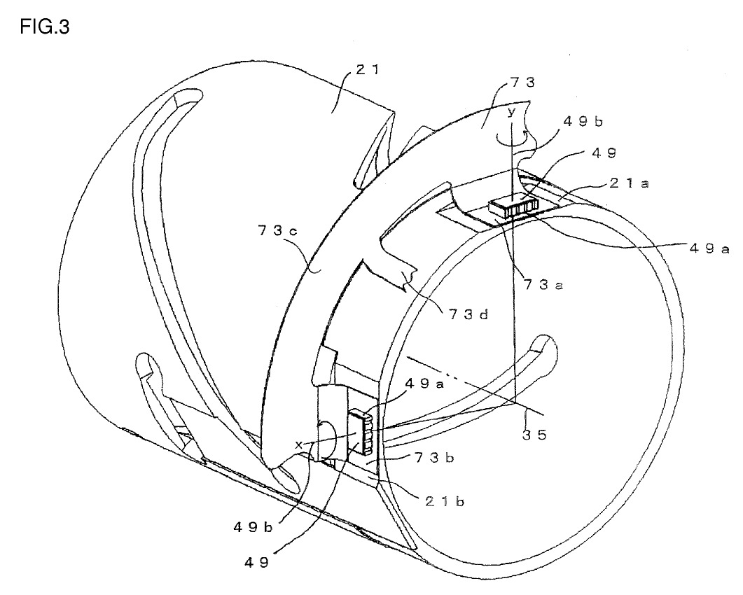

FIG. 3 illustrates details of an attachment structure of the angular velocity sensor 49 to the stationary tube 21.

A first planar part 21a is formed in parallel to the optical axis 35 on an upper part of the outer periphery of the cylindrical stationary tube 21. Also, a second planar part 21b is formed in parallel to the optical axis 35 on a lateral side of the stationary tube 21. The planar part 21a and the planar part 21b are formed around the optical axis 35 spaced apart from each other by an angle of 90 degrees.

Then, the angular velocity sensor 49 is fixed on the first planar part 21a via an attachment 73a of a flexible printed circuit substrate 73. Another one of the angular velocity sensor 49 is also fixed to the second planar part 21b via an attachment 73b of the flexible printed circuit substrate 73.

The flexible printed circuit substrate 73 has a half-ring shaped collar 73c, and the attachments 73a and 73b are formed in one piece with this collar 73c substantially at right angles thereto. An amplifier for amplifying an output from the angular velocity sensors 49 (not shown in the drawing) and a low pass filter (not shown in the drawing) are mounted on the flexible printed circuit substrate 73. Also, a connecting part 73d for a connection to a main substrate (not shown in the drawing) is formed on the flexible printed circuit substrate 73. Shake information from the angular velocity sensors 49 is transmitted to the main substrate (not shown in the drawing) via this connecting part 73d.

The angular velocity sensors 49 are mounted on the attachments 73a and 73b of the flexible printed circuit substrate 73. An attachment surface 49a of the angular velocity sensor 49 for the attachments 73a or 73b is formed perpendicularly to a sensitivity axis of the angular velocity sensor 49. Therefore, an angular velocity around the y-axis in FIG. 1 is detected by the angular velocity sensor 49 disposed on the first planar part 21a, and also an angular velocity around the x-axis in FIG. 1 is detected by the angular velocity sensor 49 disposed on the second planar part 21b. Here, the angular velocity sensor 49 is mounted such that the attachment surface 49a contacts an upper surface of the attachment 73a or 73b.

The attachments 73a and 73b of the flexible printed circuit substrate 73 are fixed to the first and the second planar parts 21a and 21b, respectively, with elastic double-sided tape (not shown in the drawing), for example. In this manner, use of the double-sided tape enables the attachments 73a and 73b to be fixed firmly to the first and the second planar parts 21a and 21b, respectively. Also, it is possible to reduce mechanical vibration propagated from a side of the stationary tube 21.

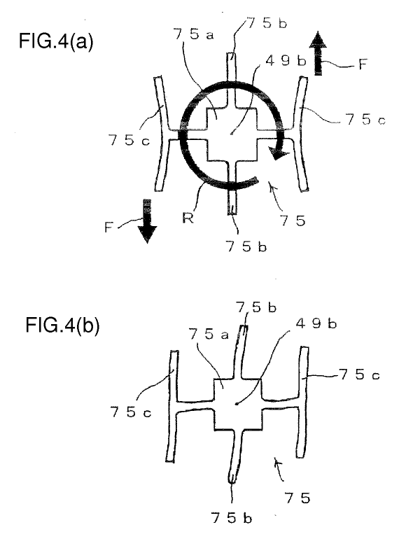

FIG. 4 illustrates the angular velocity sensor 49 in detail. This angular velocity sensor 49 includes a gyro element 75 made of single crystal quartz. This gyro element 75 includes a main part 75a, a detecting vibrating reed 75b, and a T-shaped arm 75c, and the sensitivity axis 49b is determined to be an axis passing through the center of the main part 75a and perpendicular to the page. In a usual operating state (state in which an angular velocity is not applied), only the T-shaped arm 75c of this gyro element 75 is vibrating in bending, while the detecting vibrating reed 75b is in a balanced state, as shown in FIG. 4(a). Then, when a rotation (angular velocity) R is applied around the sensitivity axis 49b, the detecting vibrating reed 75b is displaced according to a Coriolis force F as shown in FIG. 4(b), and an angular velocity is measured by differential detection of a signal generated by the displacement.

In the above described lens barrel 11, after angular velocity sensors 49 are mounted to the attachments 73a and 73b of the flexible printed circuit substrate 73, the flexible printed circuit substrate 73 is disposed at a predetermined position on the outer periphery of the stationary tube 21 and the attachments 73a and 73b are fixed onto the first and the second planar parts 21a and 21b of the stationary tube 21, respectively, with double-sided tape (not shown in the drawing), and thereby the angular velocity sensors 49 are mounted on the stationary tube 21.

Also, in the above described lens barrel 11, the planar parts 21a and 21b formed on the outer periphery of the stationary tube 21 are disposed in parallel to the optical axis 35 and the attachment surface 49a of the angular velocity sensor 49 is disposed perpendicularly to the sensitivity axis 49b. Therefore, when the attachment surface 49a of the angular velocity sensor 49 is disposed on the planar part 21a or 21b, the sensitivity axis 49b comes thereby to cross the optical axis 35 at right angles to detect an angular velocity with high accuracy.

Further, as far as the attachment surface 49a of the angular velocity sensor 49 is disposed on the planar part 21a or 21b of the stationary tube 21, wherever on the planar part 21a or 21b the angular velocity sensor 49 is disposed, the sensitivity axis 49b of the angular velocity sensor 49 crosses the optical axis 35 at right angles to provide good detection characteristics. Therefore, when the angular velocity sensor 49 is disposed on the planar part 21a or 21b, alignment of a position on the planar part 21a or 21b and an angle around the sensitivity axis 49b need not be performed with high accuracy, and thereby the angular velocity sensor 49 is easily attached onto the planar part 21a or 21b.

Further, since the planar parts 21a and 21b on which the angular velocity sensors 49 are attached have flat surfaces, not curved surfaces, the angular velocity sensors 49 can be attached easily and securely.

Also, the two planar parts 21a and 21b formed on the outer periphery of the stationary tube 21 have a simple configuration in which the planes thereof are formed on the outer periphery of the stationary tube 21 orthogonally each other, and thereby can be formed easily, securely, and with high accuracy.

Further, in the above described lens barrel 11, since the first or second planar part 21a or 21b is formed on the outer periphery of the stationary tube 21 in parallel to the optical axis 35, fixing the attachment 73a or 73b of the flexible printed circuit substrate 73 onto the first or the second planar part 21a or 21b on the stationary tube 21 makes the attachment 73a or 73b to deform in the same manner as the first or the second planar part 21a or 21b. Thereby, the attachment surface 49a of the angular velocity sensor 49 mounted on the attachment 73a or 73b becomes parallel to the first or the second planar part 21a or 21b and the sensitivity axis 49b formed perpendicularly to the attachment surface 49a of the angular velocity sensor 49 is disposed perpendicularly to the optical axis 35. Accordingly, the angular velocity sensor 49 can be attached to the stationary tube 21 easily, securely, and with high accuracy.

Also, since the attachments 73a and 73b of the flexible printed circuit substrate 73 deform in the same manner as the first and the second planar parts 21a and 21b formed on the outer periphery of the stationary tube 21 around the optical axis 35 spaced apart from each other by an angle of 90 degrees, the sensitivity axis 49b of the angular velocity sensor 49 disposed on the first planar part 21a and the sensitivity axis 49b of the angular velocity sensor 49 disposed on the second planar part 21b can be positioned to cross at right angles easily, securely, and with high accuracy.

### SECOND EMBODIMENT

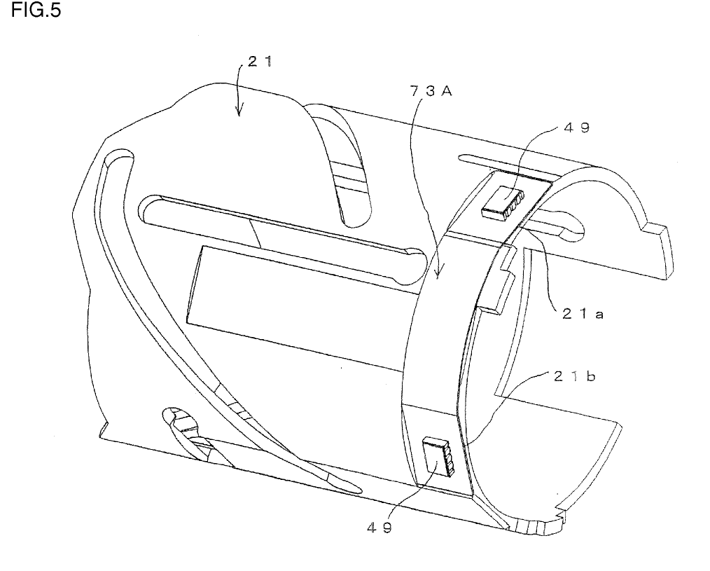

FIG. 5 illustrates a second embodiment of a lens barrel with a shake detecting function according to the present invention.

Here, the same element in this embodiment as in the first embodiment is denoted by the same symbol and detailed description will be omitted.

In this embodiment, a flexible printed circuit substrate 73A is disposed along a peripheral direction of a stationary tube 21. Angular velocity sensors 49 are fixed onto a first planar part 21a and a second planar part 21b via the flexible printed circuit substrate 73A.

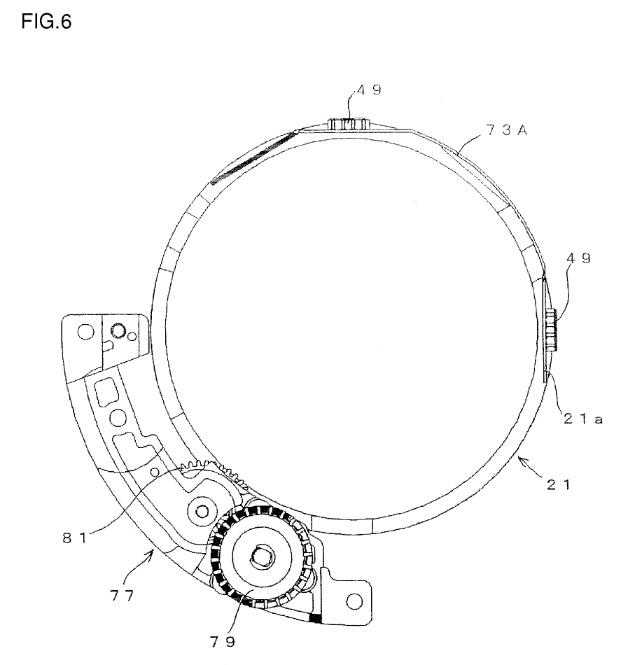

The flexible printed circuit substrate 73A is disposed across about a half of a periphery of the stationary tube 21 as shown in FIG. 6, and an ultrasonic motor unit 77 for driving an imaging optical system 17 (refer to FIG. 1) is disposed on a part of the stationary tube 21 where the flexible printed circuit substrate 73A is not disposed. The ultrasonic motor unit 77 rotates a gear 81 with an ultrasonic motor 79 to drive the imaging optical system 17.

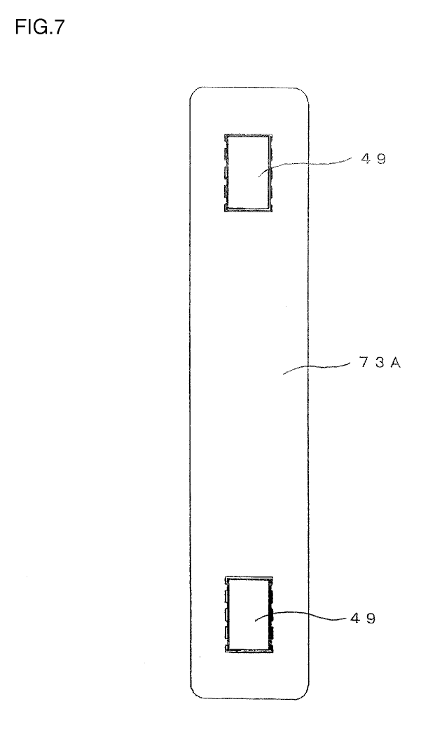

The flexible printed circuit substrate 73A has a long rectangular shape as shown in FIG. 7, and the angular velocity sensors 49 are mounted with a predetermined spacing in the longitudinal direction. The angular velocity sensor 49 is mounted such that a sensitivity axis 49b is perpendicular to the flexible printed circuit substrate 73A, and the flexible printed circuit substrate 73A is fixed to the outer periphery of the stationary tube 21 with double-sided tape (not shown in the drawing) at such a position as the angular velocity sensors 49 are disposed on a first and a second planar parts 21a and 21b, respectively.

In this embodiment, excellent advantages similar to those of the first embodiment can be obtained. In this embodiment, disposing the flexible printed circuit substrate 73A along the outer periphery of the stationary tube 21 enables the flexible printed circuit substrate 73A to have a simple structure. Also, since the ultrasonic motor 79 is disposed at a part where the flexible printed circuit substrate 73A is not disposed in the embodiment shown in the drawing, the angular velocity sensor 49 becomes less affected by a frequency of the ultrasonic motor 79, for example, even in a case a detection frequency band of the angular velocity sensor 49 and the driving frequency band of the ultrasonic motor 79 are in a frequency band in which mutual interference occurs (for example, the same frequency band or integral multiples of the frequency band). Also, since the flexible printed circuit substrate 73A is disposed across about a half of the periphery of the stationary tube 21, the ultrasonic motor unit 77 can be disposed on the stationary tube 21 at a part where the flexible printed circuit substrate 73A is not disposed. Further, the flexible printed circuit substrate 73A is disposed along the stationary tube 21, and does not have a structure protruded from the stationary tube 21 such as the collar 73c (refer to FIG. 1), resulting in downsizing a barrel by a size thereof.

### SUPPLEMENTS TO THE EMBODIMENTS

Although, hereinabove, the present invention has been described according to the above described embodiments, the scope of the technology in the present invention is not limited to the above described embodiments and may include other embodiments as follows, for example.

(1) Although an example in which a uniaxial sensor is used for the angular velocity sensor 49 has been described in the foregoing embodiments, a biaxial sensor may be used, for example. In a case a biaxial sensor is used, only one planar part may be formed on an outer periphery of a stationary tube and one of the two axes may cross the planar part orthogonally.

(2) Although an example in which the angular velocity sensor 49 is used for a shake detection sensor has been described in the foregoing embodiments, an angular displacement sensor, an angular acceleration sensor or the like may be used, for example.

(3) Although an example in which the attachments 73a and 73b of the flexible printed circuit substrate 73 are simply fixed to the first and the second planar parts 21a and 21b, respectively, with double-sided tape has been described in the foregoing embodiments, rubber plates may be fixed to the attachments 73a and 73b with double-sided tape and the rubber plates may be fixed onto the first and the second planar parts 21a and 21b with double-sided tape, for example. Intervening of a rubber plate in this manner can further reduce mechanical vibration propagated from the side of the stationary tube 21.

(4) Although an example in which the attachments 73a and 73b of the flexible printed circuit substrate 73 are fixed onto the first and the second planar parts 21a and 21b of the stationary tube 21, respectively, with double-sided tape has been described in the foregoing embodiments, the present invention is not limited to this example, and the attachments 73a and 73b of the flexible printed circuit substrate 73 may be fixed onto the first and the second planar parts 21a and 21b of the stationary tube 21, respectively, with use of adhesive or solder or the like. In a case adhesive is used, use of instant adhesive can make considerably shorter a time required for the fixing. Also, the attachments 73a and 73b can be fixed by coupling with mechanical coupling parts provided on the planar parts 21a and 21b. An important point is that sensor alignment may be performed utilizing a surface of a stationary tube.

(5) Although an example in which the angular velocity sensor is fixed onto the planar part via the flexible printed circuit substrate has been described in the foregoing embodiment, the angular velocity sensor may be attached directly onto the planar part without an intervening substrate.

(6) Although an example in which shake correction is performed by driving the shake correcting lens with use of information detected by the angular velocity sensor has been described in the foregoing embodiments, shake correction may be performed by driving an image pickup device (for example, CCD, CMOS, or the like) with use of a detected signal, or shake correction may be performed in an electronic manner or in an image processing manner with use of a detected signal.

(7) Although the planar part is formed on the outer periphery side of the stationary tube in the foregoing embodiments, a planar part may be formed on the inner periphery side. In this case, a barrel can be downsized furthermore.

(8) Although vibration of single crystal quartz is utilized for the angular velocity sensor in the foregoing embodiments, single crystal material except for quartz, for example, single crystal silicon may be used for an angular velocity sensor. Also, a variety of angular velocity sensors can be used as far as a detection axis thereof is perpendicular to an attachment.

(9) Although the present invention is exemplarily applied to an interchangeable lens detachable from a camera body in the foregoing embodiments, the present invention is not limited to this case, and can be applied to a compact camera, a movie camera, binoculars, etc. In a case the foregoing embodiments are applied to a compact camera and a movie camera, a member fixedly provided in a camera body is equivalent to the stationary tube in the foregoing embodiments. An important point is that a shake detection sensor, which has a detection axis perpendicular to an attachment, may be disposed such that the detection axis is perpendicular to an optical axis of an imaging optical system or an observing optical system.

1. A lens barrel with a shake detecting function, comprising:
a stationary tube that supports an imaging optical system; and
a shake detection sensor that detects a shake along a predetermined detection axis;
said shake detection sensor being attached to said stationary tube with said detection axis substantially orthogonal to an optical axis of said imaging optical system.

2. The lens barrel with a shake detecting function according to claim 1, further comprising a shake correction part that corrects an image shake of a captured image by said imaging optical system based on information from said shake detection sensor.

3. The lens barrel with a shake detecting function according to claim 1, wherein:
said stationary tube is provided with one or a plurality of planar parts parallel to the optical axis of said imaging optical system; and
said shake detection sensor is fixed on said planar part.

4. The lens barrel with a shake detecting function according to claim 1, wherein said planar parts are provided at two positions on an outer periphery of said stationary tube spaced apart from each other by an angle of 90 degrees.

5. The lens barrel with a shake detecting function according to claim 1, wherein said shake detection sensor is an angular velocity sensor utilizing natural frequency of a single crystal material.

6. The lens barrel with a shake detecting function according to claim 2, wherein said stationary tube integrates a detachable part that is detachable from a camera body containing a medium for recording said captured image.

7. The lens barrel with a shake detecting function according to claim 2, wherein said shake correction part drives at least a part of an imaging system that includes said imaging optical system and the medium for recording said captured image.

8. The lens barrel with a shake detecting function according to claim 1, wherein said shake detection sensor is fixed to said planar part via a flexible printed circuit substrate.

9. The lens barrel with a shake detecting function according to claim 8, wherein two or more of said shake detection sensors are provided on said flexible printed circuit substrate.

10. The lens barrel with a shake detecting function according to claim 9, wherein said flexible printed circuit substrate is disposed along a circumferential direction of said stationary tube.

11. The lens barrel with a shake detecting function according to claim 10, further comprising
an ultrasonic motor driving said imaging optical system,
said ultrasonic motor being disposed on said stationary tube at a part where said flexible printed circuit substrate is not disposed.

12. The lens barrel with a shake detecting function according to claim 8, wherein said flexible printed circuit substrate includes an attachment to which said shake detection sensor is mounted, said attachment being fixed to said planar part.

13. The lens barrel with a shake detecting function according to claim 12, wherein said attachment is fixed to said planar part with a double-sided tape.

14. An electronic device comprising a lens barrel according to claim 1.

15. An imaging method comprising the step of attaching a shake detection sensor to a lens barrel such that a detection axis of said shake detection sensor is substantially orthogonal to an axis direction of said lens barrel.
